(19) United States
(12) Patent Application Publication
(10) Pub. No.: US 2008/0127786 A1
(43) Pub. Date: Jun. 5, 2008

(54) Hand tool with earphone

(76) Inventor: Chih-Ching Hsieh, Taichung (TW)

Correspondence Address: Chih-Ching Hsieh, 235 Chung - Ho, Box 8-24, Taipei, omitted

(21) Appl. No.: 11/633,225

(22) Filed: Dec. 5, 2006

(51) Int. Cl. B25B 23/159

(52) U.S. Cl. 81/477

(57) ABSTRACT

A hand tool with an earphone comprises a hand tool having an earphone hole for output sound from the hand tool. The hand tool is installed with an earphone. The hand tool is an electronic spanner. The hand tool is installed with a digital processor which stores with music file. The digital processor stores setting values about twisting force.

### FIELD OF THE INVENTION

The present invention relates to hand tools, and particularly to a hand tool with an earphone, wherein the hand tool is installed with a digital processor which stores music and setting value about the twisting force applied to the hand tools so that as the applied twisting force is greater than the setting value, the user will be alerted, moreover, the user can hear music in working.

### BACKGROUND OF THE INVENTION

Currently, the conventional hand tools are arranged with electronic devices, for example, strain gauges are widely applied to various spanners. Furthermore, some alert devices are equipped to the spanners for alerting the user that the applied twisting force is greater than a predetermined value so that the user can adjust the operation not to destroy the spanner or the driven object.

The general principle for measuring strain is to measure the pressure in some positions of the hand tools, generally, the positions are easily deformable portions of the hand tool. The pressure is transferred to the gauge for converting into twisting force. The twisting force value is displayed on a display on the hand tool. In some design, if an over-large force is applied, an alarm is emitted to the user by light effect or sound effect.

However in many working environment, noises are very large, which deeply affect the hearing ability of the worker so that it is often that the worker cannot hear the noises. As a result, the user cannot alert that the applied force has attained to a preset twisting value and the operation is continued. It is often that some expensive instruments will be destroyed.

### SUMMARY OF THE INVENTION

Accordingly, the primary object of the present invention is to provide a hand tool with an earphone, wherein the hand tool is installed with a digital processor which stores music and setting value about the twisting force so as the applied twisting force is greater than the setting value, the user will be altered, moreover, the user can hear music in working.

To achieve above objects, the present invention provides a hand tool with an earphone which comprises a hand tool having an earphone hole for output sound from the hand tool. The hand tool is installed with an earphone. The hand tool is an electronic spanner. The hand tool is installed with a digital processor which stores with music file. The digital processor stores setting values about twisting force.

The various objects and advantages of the present invention will be more readily understood from the following detailed description when read in conjunction with the appended drawing.

### BRIEF DESCRIPTION OF THE DRAWINGS

FIG. 1 is a schematic view about the hand tool with an earphone of the present invention.

FIG. 2 is a schematic perspective view of the hand tool with an earphone of the present invention.

FIG. 3 shows the second embodiment of the present invention.

FIG. 4 shows the third embodiment of the present invention.

FIG. 5 shows the fourth embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

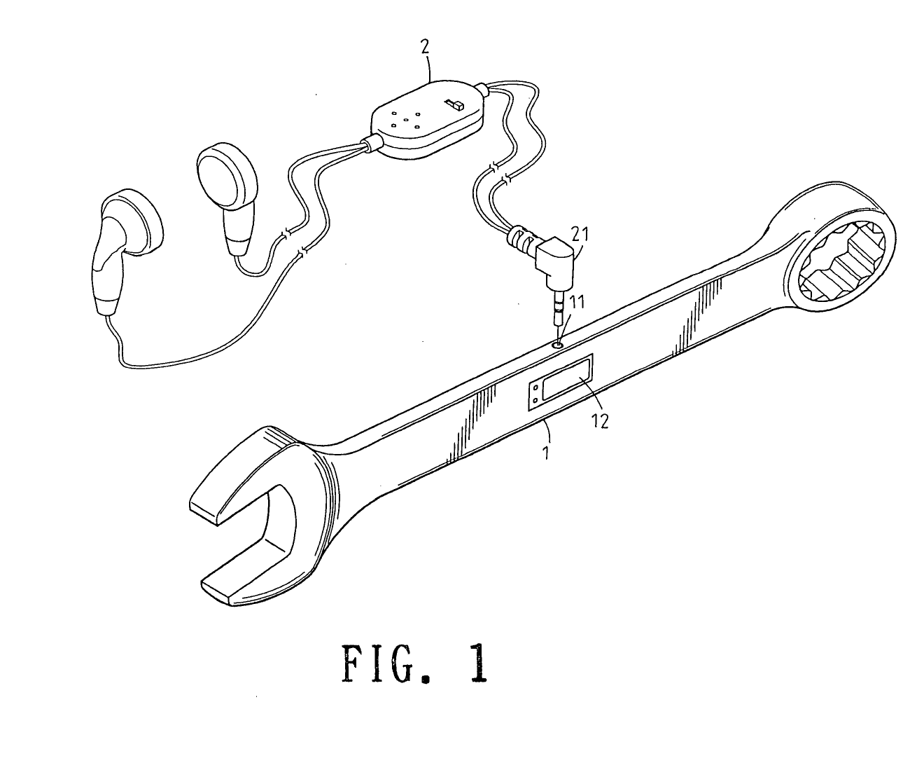

Referring to FIG. 1, the hand tool with earphone function of the present invention is illustrated. The present invention includes a hand tool 1 has an earphone hole 11 at a predetermined position for speech output of the hand tool 1. The hand tool 1 further has an electronic panel 12 which is connected to a digital processor (not shown). The digital processor is connected to the earphone hole 11.

The digital processor can emit sound as the applied twisting force has achieved to a predetermined value. The digital processor further stores music files. Thus, the user can hear the music in working.

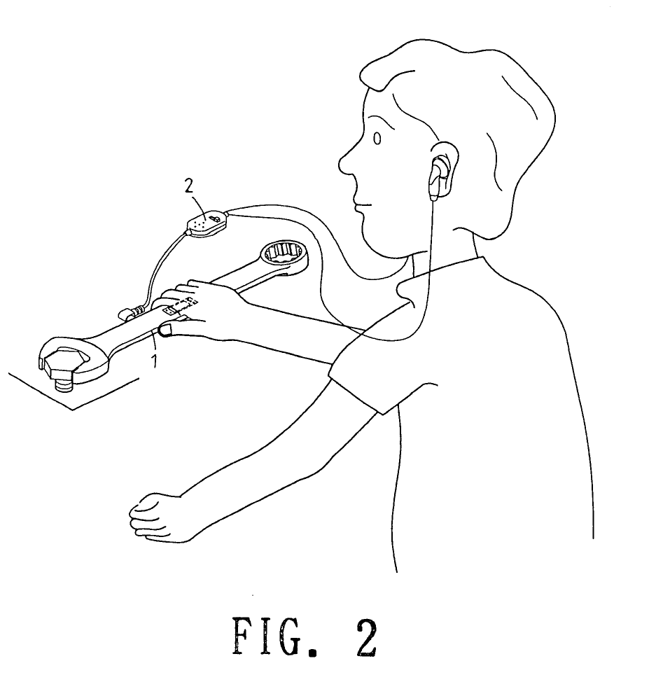

With referring to FIG. 2, when the user operates the hand tool 1 of the present invention, the user can set a desired twisting force value, the plug 21 of the earphone 2 is inserted into the earphone hole 11. Then the user wears the earphone 2 on the ears. Then the user can be alerted to known whether the twisting force applied has achieved to a predetermined twisting value.

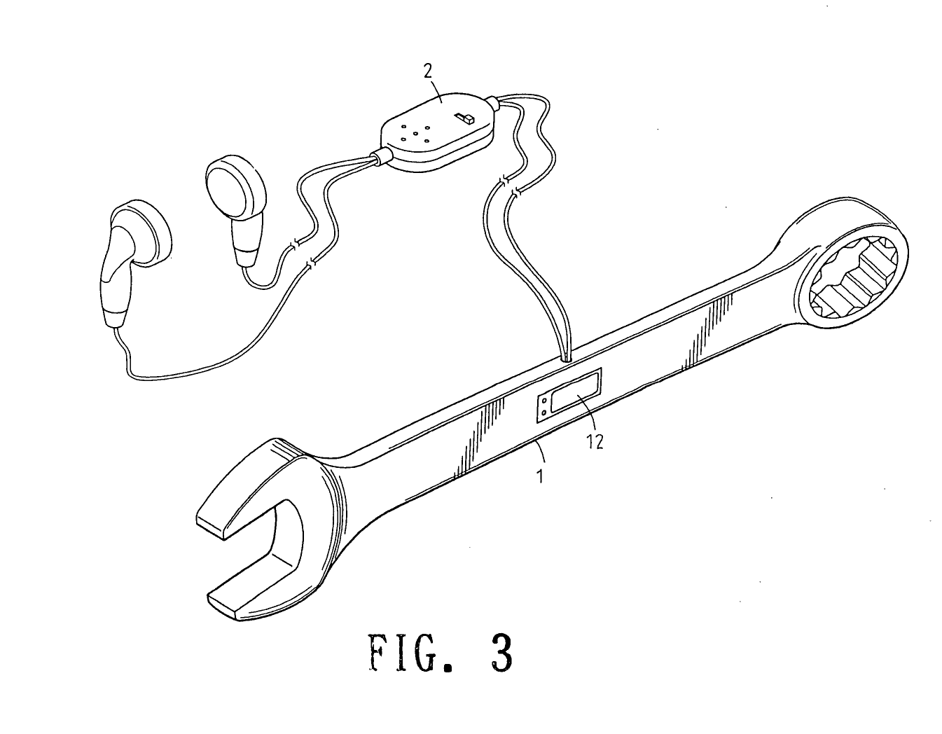

Referring to FIG. 3, the second embodiment of the present invention is illustrated. The present invention has a hand tool 1. A predetermined position of the hand tool 1 is connectable to an earphone 2 for outputting sounds from the hand tool 1. The hand tool 1 is installed with an electronic panel 12. A digital processor is connected in the electronic panel 12. The digital processor is connected to the earphone 2.

The digital processor can emit sound as the applied twisting force has achieved to a predetermined value. The digital processor further stores music files. Thus, the user can hear the music in working.

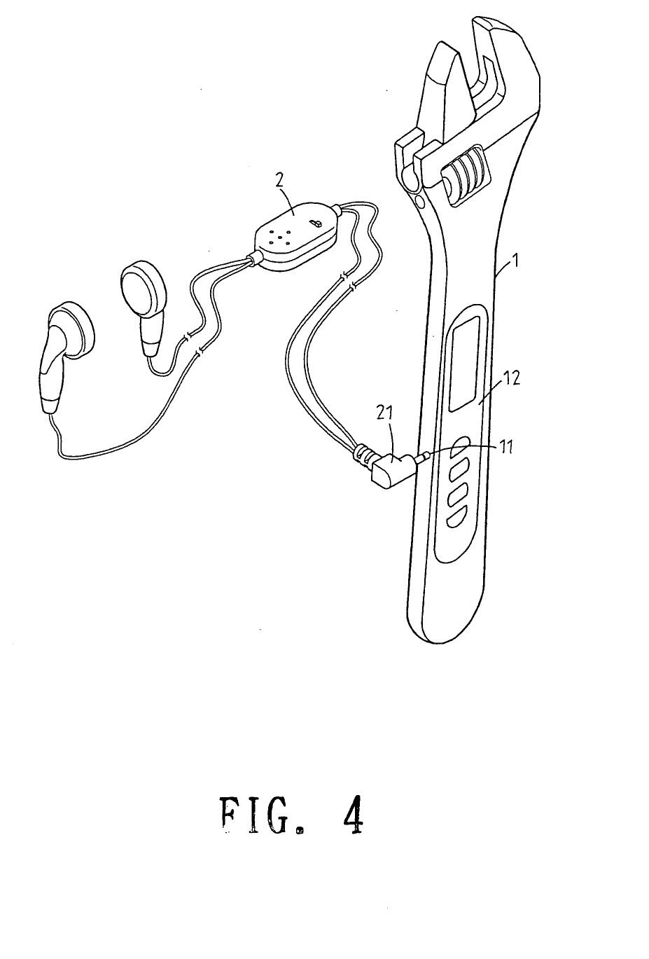

With referring to FIG. 4, the third embodiment of the present invention is illustrated. The present invention is used to an electronic adjustable spanner. The present invention has a hand tool 1. A predetermined position of the hand tool 1 is connectable to an earphone 2 for outputting sounds from the hand tool 1. The hand tool 1 is installed with an electronic panel 12. A digital processor is connected in the electronic panel 12. The digital processor is connected to the earphone 2.

The digital processor can emit sound as the applied twisting force has achieved to a predetermined value. The digital processor further stores music files. Thus, the user can hear the music in working.

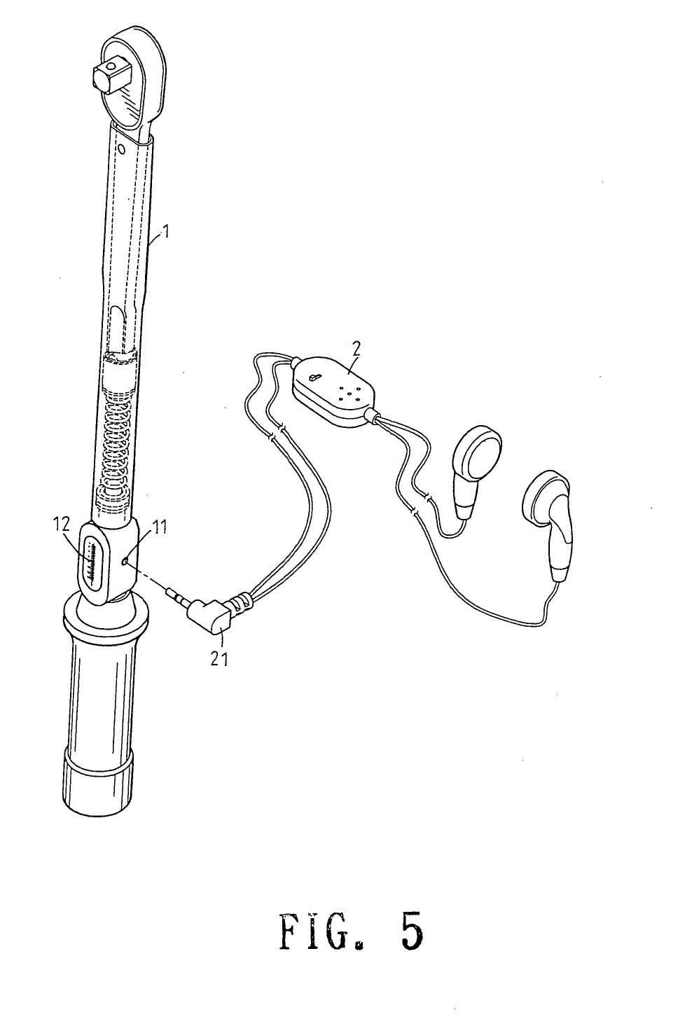

With referring to FIG. 5, the fourth embodiment of the present invention is illustrated. The present invention is used to a spanner with a strain gauge. The present invention has a hand tool 1. A predetermined position of the hand tool 1 is connectable to an earphone 2 for outputting sounds from the hand tool 1. The hand tool 1 is installed with an electronic panel 12. A digital processor is connected in the electronic panel 12. The digital processor is connected to the earphone 2.

The digital processor can emit sound as the applied twisting force has achieved to a predetermined value. The digital processor further stores music files. Thus, the user can hear the music in working.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A hand tool with an earphone comprising:
a hand tool having an earphone hole for outputting sound from the hand tool; wherein the hand tool having an electronic panel at a front side thereof; and
an earphone having a plug capable of being inserted into the earphone hole:

2. (canceled)

3. The hand tool with an earphone as claimed in claim 2, wherein the hand tool 1 is an electronic spanner; and
wherein the hand tool is installed with a digital processor which stores with music file; and
wherein the digital processor further stores setting values about twisting force; the digital processor can emit sound as the applied twisting force has achieved to a predetermined value.

4-5. (canceled)
